(19) United States
(12) Patent Application Publication
(10) Pub. No.: US 2003/0223907 A1
(43) Pub. Date: Dec. 4, 2003

(54) Positioning device

(76) Inventors: Michael Schmelz, Griesheim (DE); Alexander Gross, Babenheusen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/296,464

(22) PCT Filed: May 28, 2001
(86) PCT No.: PCT/EP01/06044

(30) Foreign Application Priority Data
May 29, 2000 (DE) 100266479

(51) Int. Cl. G01N 35/00

(52) U.S. Cl. 422/63; 422/104

(57) ABSTRACT

A positioning device for a plurality of microreactors which are arranged in the form of a flat, rectangular microreactor plate (4) has a support frame (1) with a cutout (2). A spring element (3) fixes the microreactor plate (4) so that it presses laterally against the support frame (1). The support frame (1) together with the microreactor plate (4) can be positioned on a baseplate in such a manner that there is no risk of incorrect positioning, which baseplate may include integrated devices required for the reaction sequences and analyses.

The invention relates to a positioning device for a plurality of microreactors which are arranged in the form of a flat, rectangular microreactor plate and each at least comprise a small cavity.

Microreactors allow chemical reactions to be carried out in an extremely small space and with minimal use of reagents. On account of their very small dimensions, in each case a large number of microreactors of this type are combined, in the form of a matrix, to form a microreactor plate. One possible design of a microreactor plate of this type comprises a silicon plate in which a large number of small cavities are etched in order for individual reactions to be carried out. Each individual cavity may be provided with additional features, such as for example a screening base. The miniaturisation allows a very large number of individual reactions and analyses to be carried out simultaneously. As a result, investigations into the action of novel substances in the chemical/pharmaceutical field can be carried out significantly more economically and rapidly.

In the context of an investigation of this type, the cavities are usually firstly filled with one substance which is to be studied and then with one or more reagents. After the reaction has taken place, the reagents are sucked out, for example via a screening base. The reaction products can then be chemically or physically analysed.

A significant, recurring problem involved in using microreactor plates of this type is the interface between the microtechnology and macrotechnology.

Since the size of the microreactor plate remains small even if there is a large number of individual reactors, and since the mechanical stability of this plate is low, a device is required which can be used to handle the microreactor plate during the analyses. It is an almost imperative precondition for economic work with microreactor plates that necessary process steps, such as for example the step of introducing the substances into individual microreactors or the steps of pipetting or sucking out the reagents, be substantially automated.

Accordingly, it is an object of the invention to design a device for simple handling and positioning of microreactor plates in such a way that the microreactor plates can be used reproducibly and reliably during individual process steps and it is possible for reagents to be metered into and sucked out of individual microreactors.

According to the invention, this object is achieved by the fact that the positioning device has a support frame with a cutout which is, matched to the shape of a microreactor plate and with a spring element which presses laterally against the microchamber plate, and that the support frame can be positioned on a baseplate.

The microreactor plate can be placed quickly and easily into the corresponding cutout in the support frame. By means of the spring element, the microreactor plate is pressed laterally onto stops which delimit the cutout and is thus fixed securely in the support frame. Therefore, during the subsequent analyses, the microreactor plate is protectively surrounded by the support frame on virtually all sides. The support frame itself may be laid onto a baseplate in which devices which are required during subsequent process steps may already be integrated.

Preferably, the spring element has two curved spring limbs which protrude at right angles. By means of the curved spring limbs which protrude at right angles, the microreactor plate is pressed laterally against stops of the support frame which are provided for this purpose and is reliably held in this position. On account of the low spring excursion, the microreactor plate can be inserted quickly and easily into the support frame.

According to one configuration of the inventive idea, it is provided for it to be possible to attach a holding frame, which fixes the microreactor plate from above, to the support frame. A holding frame of this type prevents the microreactor plate from dropping out of the support frame while the desired process steps are being carried out. The holding frame additionally increases the stability of the microreactor plate and of the support frame.

It is preferably provided for the support frame, at least at one corner, to have a bevel and for the baseplate to have a matching moulded protrusion. Particularly with a view to automated handling of the microreactor plate situated in the support frame, the bevel of the support frame and the corresponding moulded protrusion on the baseplate ensure that the support frame can only be positioned on the baseplate in constant orientation with respect to the baseplate.

According to one advantageous configuration of the inventive idea, it is provided for the support frame, on one or more side faces, to have at least one cutout or groove which are provided for the purpose of simple automated handling. For economic reasons, it is desirable for individual process and transfer steps to be substantially,, automated. Secure gripping and transporting of the support frame using automatic devices is considerably simplified by cutouts or grooves of this type. Furthermore, cutouts or grooves of this type, in addition to the bevel on the support frame, may allow the support frame to be positioned accurately and without error not only on the baseplate but also in combination with other laboratory equipment.

According to one advantageous embodiment of the inventive idea, the baseplate has a recess which is matched to the shape of the microreactor plate. If the microreactor plate held by the support frame is positioned on the baseplate, the microreactor plate together with the support frame covers the recess in the baseplate completely and in a sealed manner. The resultant cavity beneath the microreactor plate can be used for process steps which are required as part of the analyses, such as filling or emptying of the individual microreactors. As a result, frequently occurring process steps can be carried out in an automated manner without the support frame having to be removed from the baseplate.

Preferably, the baseplate has a lateral opening leading to the recess. Via this opening it is possible, for example, to produce a vacuum in the cavity which is formed by the recess in the baseplate and the microreactor plate fixed in the support frame. This vacuum primarily allows simple filling of the individual microreactors. Process steps such as sucking reagents out of the microreactors and washing the residues are significantly facilitated by the vacuum in the cavity.

Embodiments of the invention are explained in more detail below and are illustrated in the drawing, in which:

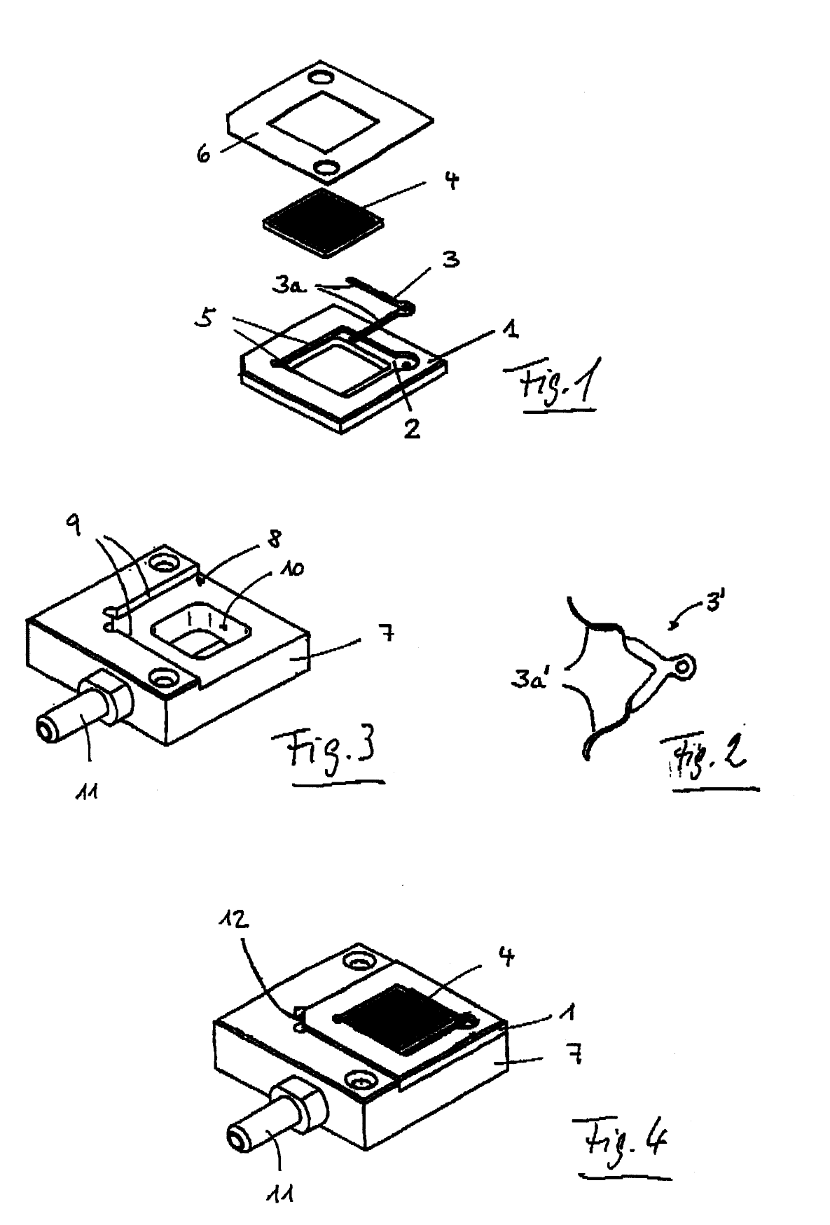

FIG. 1 shows a support frame, a spring element, a microreactor plate and a holding frame in an exploded view,

FIG. 2 shows an enlarged view of a similar spring element,

FIG. 3 shows a view of a baseplate, and

FIG. 4 shows a view of the assembled individual parts shown in FIG. 1 which have been placed onto the baseplate.

A support frame 1 which is illustrated in FIG. 1 has a substantially rectangular cutout 2, which is intended to accommodate a spring element 3 and a microreactor plate 4. The shape of the cutout 2 produces a surrounding bearing surface, which is delimited by stops 5, for the microreactor plate 4. A cylindrically widened corner of the cutout 2 serves to accommodate the spring element 3, of which the spring limbs 3a, which project at right angles, extend along two sides of the cutout 2. As a result of the two spring limbs 3a of the spring element 3 being pressed back slightly, the microreactor plate 4 can easily be inserted into the cutout 2 in the support frame 1. The two spring limbs 3a press the microreactor plate 4 onto the opposite stops 5 of the support frame 1 and thus prevent the microreactor plate 4 from inadvertently becoming detached from the support frame 1. A holding frame 6 which can be attached to the support frame 1 has an opening which matches the dimensions of the microreactor plate 4, so that in the assembled state only an unused edge region is covered, while microchambers of the microreactor plate 4 are not covered. The spring element 3 and the microreactor plate 4 are then fixed securely between the holding frame 6 and the support frame 1.

A slightly different exemplary embodiment of a spring element 3′, which is illustrated on an enlarged scale in FIG. 2, has two curved spring limbs 3a′ which project at right angles. The spring element 3′ which is designed in this way, despite the low spring excursion of the individual spring limbs 3a′, ensures that the microreactor plate 4 is pressed sufficiently firmly against the stops 5 of the support frame 1 without there being any risk of the microreactor plate 4 being destroyed or damaged as a result of excess loads being applied.

FIG. 3 shows a view of a substantially cuboidal baseplate 7, the upper side of which has a cutout 8 which is matched to the support frame 1 and is arranged slightly offset.

A protrusion 9, which delimits the cutout 8 of the baseplate 7 on two sides at right angles to one another serves as a stop for the support frame 1. Beneath the cutout 8 for the support frame 1 there is a further recess 10 which is matched to the dimensions of the microreactor plate 4. The recess 10 has a lateral opening 11, which is designed as a hollow cylindrical connection piece.

As soon as the support frame 1 with a microreactor plate 4 inside it is laid onto the baseplate 7 at the location of the cutout 8, the recess 10 becomes a closed cavity which only has the lateral opening 11. A vacuum can be produced in the cavity formed via this opening 11. This vacuum allows or facilitates individual process steps, such as for example the filling or emptying of the microreactors.

FIG. 4 shows the baseplate 7, the support frame 1 and the microreactor plate 4 in the assembled state. Two sides of the support frame 1 end flush with the outer sides of the, baseplate 7. The support frame 1 is oriented without any possibility of error with respect to the baseplate 7 by means of a bevel 12 on one corner of the support frame 1. A moulded protrusion of the baseplate 7 which matches the bevel 12 of the support frame 1 prevents there being any possibility of a support frame 1 being positioned flush on the baseplate 7 in an incorrect orientation.

1. Positioning device for a plurality of microreactors which are arranged in the form of a flat, rectangular microreactor plate and each at least comprise a small cavity, characterized in that the positioning device has a support frame (1) with a cutout (2) which is matched to the shape of the microreactor plate (4) and with a spring element (3, 3′) which presses laterally against the microchamber plate (4), and in that the support frame (1) can be positioned on a baseplate (7).

2. Positioning device according to claim 1, characterized in that the spring element (3′) has curved spring limbs (3a′) which project at right angles.

3. Positioning device according to claim 1, characterized in that a holding frame (6) which fixes the microreactor plate (4) in place can be attached to the support frame (1).

4. Positioning device according to claim 1, characterized in that the support frame (1), at least at one corner, has a bevel (12), and the baseplate (7) has a matching moulded protrusion.

5. Positioning device according to claim 1, characterized in that the support frame (1) on one or more side faces, has at least one cutout or groove which is provided for the purpose of simple automated handling.

6. Positioning device according to claim 1, characterized in that the baseplate (7) has a recess (10) which is matched to the shape of the microreactor plate (4).

7. Positioning device according to claim 6, characterized in that the baseplate (7) has a lateral opening (11) leading to the recess (10).
